(19) United States
(12) Patent Application Publication
(10) Pub. No.: US 2024/0365133 A1
(43) Pub. Date: Oct. 31, 2024

(54) WIRELESS NODE DEVICE

(71) Applicant: Realtek Singapore Private Limited, Singapore (SG)

(72) Inventor: Yi-Wei CHEN, Singapore (SG)

(21) Appl. No.: 18/308,039

(22) Filed: Apr. 27, 2023

(30) Foreign Application Priority Data
Feb. 17, 2023 (CN) 202310135217.2

(51) Int. Cl. H04W 16/22

(52) U.S. Cl. CPC H04W 16/22

(57) ABSTRACT

A wireless node device includes a neural network module, a wireless network communication circuit, and a control circuit. The neural network module has a plurality of trained parameters. The control circuit is coupled to the neural network module and the wireless network communication circuit. The control circuit obtains, from the wireless network communication circuit, a plurality of current state data corresponding to a plurality of time points, and loads the neural network module to obtain estimated network data based on the current state data. The control circuit controls the wireless network communication circuit according to the estimated network data.

### BACKGROUND

### Technical Field

The present disclosure relates to network control technology, in particular to a wireless node device.

### Related Art

Current network traffic control methods tend to determine whether to switch channels only according to the signal strength change of the channels. In addition, although the current multi-AP network can support multiple radio frequency bands, which allows the access point to switch radio frequency bands, the radio frequency bands usually use preset channels, and if the preset channels are not in good condition, no matter how to switch radio frequency bands, the network condition cannot be improved.

### SUMMARY

An embodiment of the present disclosure provides a wireless node device, including: a first neural network module, a wireless network communication circuit and a control circuit. The first neural network module has a plurality of first trained parameters. The control circuit is coupled to the first neural network module and the wireless network communication circuit, and configured to obtain, from the wireless network communication circuit, a plurality of current state data corresponding to a plurality of time points, load the first neural network module to obtain estimated network data based on the current state data, and control the wireless network communication circuit according to the estimated network data.

According to the wireless node device provided in some embodiments of the present disclosure, the network condition can be predicted in the wireless node device through a neural network model and a traffic control policy can be determined. Moreover, the current state data can be transmitted to the electronic device so as to be trained, and the updated training parameters can be transmitted back to the wireless node device for updating. In this way, the neural network model can continuously learn and adapt to the user's habits and environment, and generate the traffic control policy according to the latest parameters.

### BRIEF DESCRIPTION OF THE DRAWINGS

FIG. 1 is a schematic diagram showing an architecture of a network traffic control system according to an embodiment of the present disclosure;

FIG. 2 is an internal schematic diagram of a wireless node device according to an embodiment of the present disclosure;

FIG. 3 is an internal schematic diagram of an electronic device according to an embodiment of the present disclosure;

FIG. 4 is a schematic diagram of a neural network structure according to an embodiment of the present disclosure;

FIG. 5 is a schematic diagram showing units of a long short-term memory according to an embodiment of the present disclosure;

FIG. 6 is a schematic diagram showing the operation of a first neural network module of the wireless node device according to an embodiment of the present disclosure;

FIG. 7 is a schematic diagram showing the operation of a second neural network module of the electronic device according to an embodiment of the present disclosure;

FIG. 8 is a flowchart showing the operation of a network traffic control system according to an embodiment of the present disclosure;

FIG. 9 is a schematic diagram (I) showing contents of upload data transmitted by the wireless node device according to an embodiment of the present disclosure;

FIG. 10 is a schematic diagram (II) showing contents of upload data transmitted by the wireless node device according to an embodiment of the present disclosure; and

FIG. 11 is a schematic diagram showing contents of download data received by the wireless node device according to an embodiment of the present disclosure.

### DETAILED DESCRIPTION

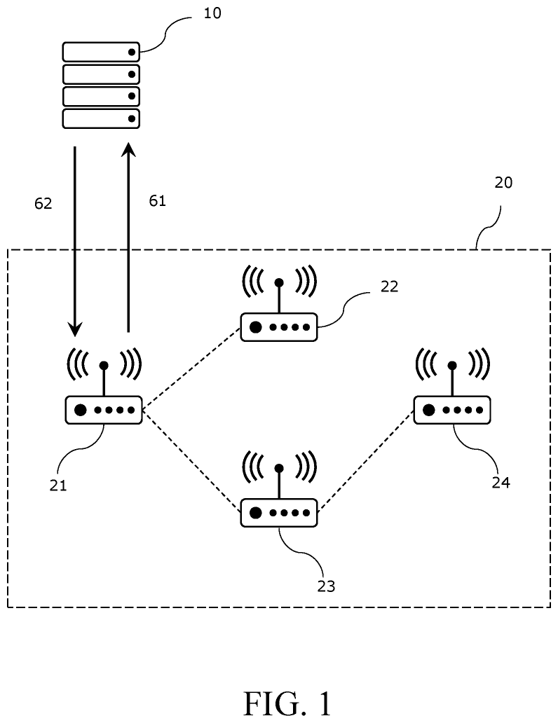

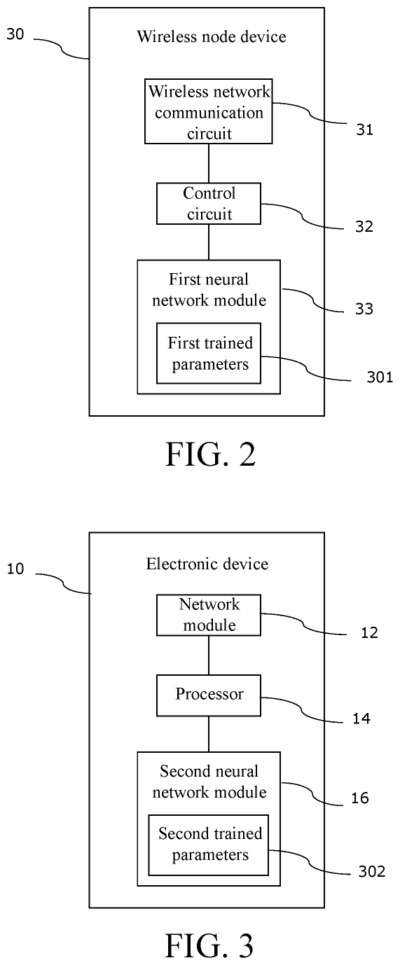

FIG. 1 is a schematic diagram of showing an architecture of a network traffic control system according to an embodiment of the present disclosure. The network traffic control system includes an electronic device 10 and at least one wireless node device 30 (as shown in FIG. 2), and is suitable for managing a multi-AP network 20. The multi-AP network 20 includes one or more network nodes (illustrated here with four network nodes 21 to 24). Each of the network nodes 21 to 24 is a wireless node device 30.

In some embodiments, the network nodes 21 to 24 are compliant with multi-AP standards of the Wi-Fi Alliance. The multi-AP network 20 is a controller-agent-client architecture including a controller and a plurality of agents, and is configured to provide network services to one or more clients. The network node 21 includes a controller, and the network nodes 21 to 23 include an agent, respectively. In some embodiments, the network node 21 also includes an agent. The network nodes 21 to 24 further include a fronthaul basic service set (BSS) and a backhaul BSS, respectively. The fronthaul BSS is configured to provide a Wi-Fi fronthaul link for client network connection. Each of the network nodes 21 to 24 further includes a backhaul STA to form a network link with the backhaul BSS of one of the other network nodes 21 to 24. The network nodes 21 to 24 may further include an Ethernet port configured to realize wired Ethernet connection. Generally speaking, the network node 21 is a gateway configured to connect a residential network to the infrastructure of a service provider. For the control details, reference may be made to the multi-AP standards, which will not be described in detail here. It should be noted here that the dashed lines in FIG. 1 indicate the backhaul link relationship between the network nodes 21 to 24. In this embodiment of the present disclosure, it is possible to adaptively control the backhaul links between the network nodes 21 to 24 to adjust to an appropriate radio wave with a specific frequency band (such as 2.4 GHz, 5 GHz or the like); and adjust to an appropriate channel.

FIG. 2 is an internal schematic diagram of the wireless node device 30 according to an embodiment of the present disclosure. The wireless node device 30 includes a wireless network communication circuit 31, a control circuit 32 and a first neural network module 33. The control circuit 32 is coupled between the wireless network communication circuit 31 and the first neural network module 33. The control circuit 32 includes at least one of the following processing units: a central processing unit (CPU), a graphics processing unit (GPU) and a tensor processing unit (TPU), and the number of the same type of processing units is not limited to one. The wireless network communication circuit 31 provides network functions that are compliant with the multi-AP standards. The first neural network module 33 is a model having a neural network structure stored in a nonvolatile memory. The neural network model has a plurality of first trained parameters 301 that are pre-trained. In some embodiments, the wireless node devices 30 are preset to store the same first trained parameters 301.

FIG. 3 is an internal schematic diagram of the electronic device 10 according to an embodiment of the present disclosure. The electronic device 10 includes a network module 12, a processor 14 and a second neural network module 16. The processor 14 is coupled between the network module 12 and the second neural network module 16. The processor 14 includes at least one of the following processing units: a central processing unit (CPU), a graphics processing unit (GPU) and a tensor processing unit (TPU), and the number of the same type of processor units is not limited to one. The network module 12 is connected to a network (e.g., the Internet) so as to communicate with the wireless node devices 30 via the network. The second neural network module 16 is a model having a neural network structure stored in a nonvolatile memory. The neural network model has a plurality of second trained parameters 302 that are pre-trained. Here, the first neural network module 33 and the second neural network module 16 have the same neural network structure. In some embodiments, the electronic device 10 is a local apparatus, such as a mobile phone, a computer, a server, a server cluster or the like. In some embodiments, the electronic device 10 is a cloud apparatus, such as a server, a server cluster or a distributed server cluster. In some embodiments, the first trained parameters 301 and the second trained parameters 302 are preset to be the same parameters.

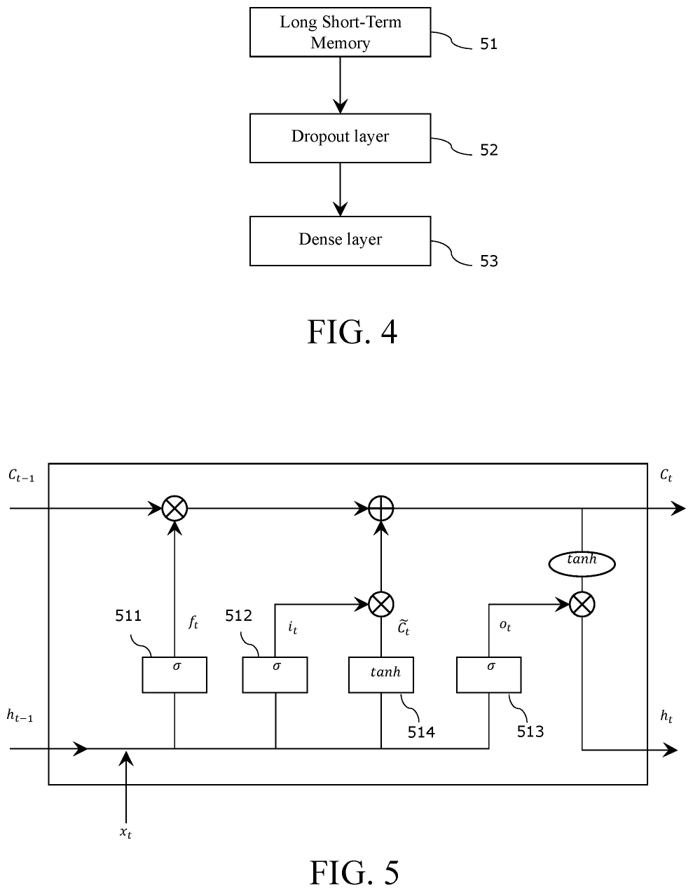

In some embodiments, the neural network structure of the first neural network module 33 and the second neural network module 16 includes a recurrent neural network (RNN) structure (such as a recurrent neural network structure designed with Pytorch or Tensorflow). Specifically, the recurrent neural network is realized by a long short-term memory (LSTM) 51 (as shown in FIG. 4). The long short-term memory 51 is suitable for processing and predicting important events with very long intervals and latencies in a time series, and suitable for establishing a traffic control policy according to the user's lifestyle and the state of time and space in the environment. For example, when it is predicted that a channel 44 will encounter high traffic at eight o'clock in the evening, it is possible to prevent network latencies and maintain high-speed network services by switching to different channels 149.

FIG. 4 is a schematic diagram of a neural network structure according to an embodiment of the present disclosure. The neural network structure of the first neural network module 33/second neural network module 16 includes at least a long short-term memory 51 and a dense layer 53. In some embodiments, the neural network structure of the first neural network module 33/second neural network module 16 further includes a dropout layer 52, located between the long short-term memory 51 and the dense layer 53 to prevent over-fitting. In some embodiments, the dense layer 53 receives outputs of the long short-term memory 51 and performs classification according to output results of the long short-term memory 51 to obtain a recommendation weight of each channel at one or more time points in the future. In some embodiments, the dense layer 53 receives outputs of the long short-term memory 51 and performs classification according to output results of the long short-term memory 51 to obtain which specific BSS of each wireless node device 30 has better performance at one or more time points in the future.

FIG. 5 is a schematic diagram showing units of the long short-term memory 51 according to an embodiment of the present disclosure. xₜ is the current input. hₜ is the current output. hₜ₋₁ is the previous output. Cₜ is the current unit state, and Cₜ₋₁ is the previous unit state. The long short-term memory 51 includes three gate layers 511, 512, 513 and one tanh layer 514. Each of the gate layers 511, 512, 513 is a Sigmoid(σ) layer. The gate layer 511 is used as a forgetting gate layer to determine which messages are to be discarded or retained from the unit state. The gate layer 511 receives the previous output hₜ₋₁ and the current input xₜ, and outputs fₜ. For each value in the previous unit state Cₜ₋₁, fₜ includes a value between 0 and 1, where 0 means complete forgetting and 1 means complete retention. The tanh layer 514 receives the previous output hₜ₋₁ and the current input xₜ, and outputs the intermediate unit state \tilde{C}ₜ. The gate layer 512 receives the previous output hₜ₋₁ and the current input xₜ, and outputs iₜ. The gate layer 512 is used as an input gate layer to determine what new messages will be stored in the current unit state Cₜ, i.e., which messages are important to retain (output iₜ) from the output (intermediate unit state Cₜ) of the tanh layer 514. The gate layer 513 receives the previous output hₜ₋₁ and the current input xₜ, and outputs oₜ. The gate layer 513 is used as an output gate layer to determine what the current output hₜ is, i.e., what messages (output oₜ) the hidden state should carry from the second tanh output (tanh Cₜ).

After the two inputs (the current input xₜ and the previous output hₜ₋₁) enter the units of the long short-term memory 51, the gate layer 511 (forgetting gate layer) determines, based on the trained weight parameters, which data in the previous unit state Cₜ₋₁ should be forgotten when the current input xₜ is seen, and multiplies them with the previous unit state Cₜ₋₁ to filter out unimportant information. Next, the gate layer 512 (input gate layer) separately calculates update data iₜ and possible state of a creation unit (intermediate unit state Cₜ) and multiplies them to obtain data to be updated. The data to be updated and the filtered data are added to complete the updating of the current unit state Cₜ. Finally, the gate layer 513 (output gate layer) obtains values of the two inputs through the Sigmoid function, and multiplies them with the current unit state Cₜ just calculated through the tanh function to obtain the current output hₜ.

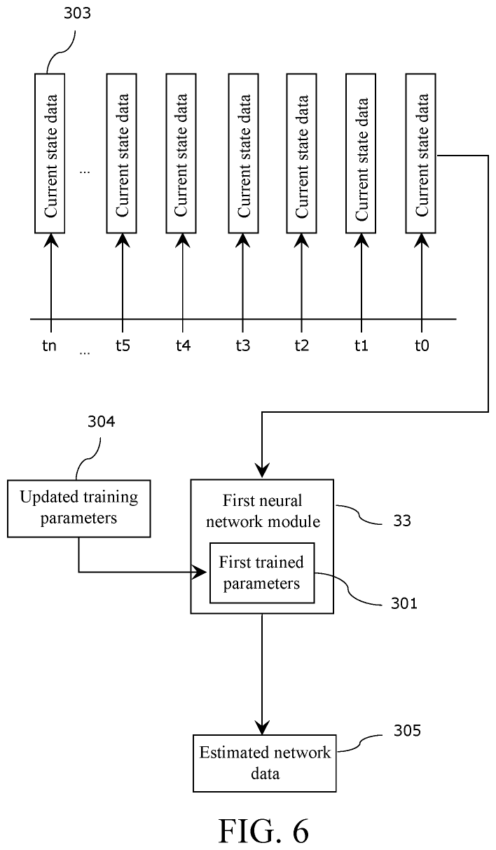

FIG. 6 is a schematic diagram showing the operation of the first neural network module 33 of the wireless node device 30 according to an embodiment of the present disclosure. The control circuit 32 of the wireless node device 30 obtains, from the wireless network communication circuit 31, a plurality of current state data 303 corresponding to a plurality of time points t0 to tn, and loads the first neural network module 33 to obtain estimated network data 305 based on the current state data 303. In other words, the control circuit 32 inputs the current state data 303 into the first neural network module 33 and obtains the estimated network data 305 from the output result of the first neural network module 33. Then, the control circuit 32 controls the wireless network communication circuit 31 according to the estimated network data 305. Thereby, the network state of the time point in the future can be estimated according to the current and past network states to adjust the appropriate traffic control policy, thereby controlling the wireless network communication circuit 31.

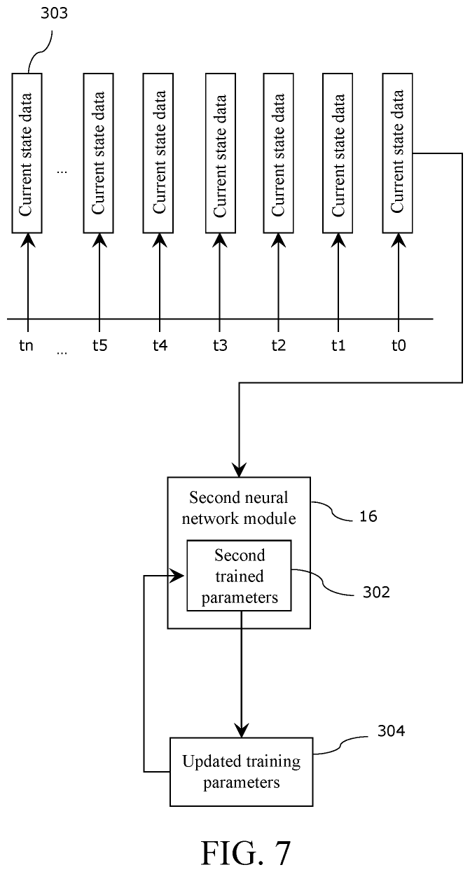

FIG. 7 is a schematic diagram showing the operation of the second neural network module 16 of the electronic device 10 according to an embodiment of the present disclosure. The wireless node device 30 transmits the current state data 303 to the electronic device 10 in batches via the network. The processor 14 of the electronic device 10 retrains the second neural network module 16 based on the current state data 303 to obtain a plurality of updated training parameters 304 (i.e., parameter configuration of the second neural network module 16 after this retraining). The processor 14 updates the second trained parameters 302 according to the updated training parameters 304, that is, updates the contents of the original second trained parameters 302 of the second neural network module 16 to the contents of the updated training parameters 304, so that the neural network model can continuously learn and adapt to the user's habits and environment.

Still referring to FIG. 6, the electronic device 10 further transmits the updated training parameters 304 back to the wireless node device 30 via the network module 12, so that the wireless node device 30 updates the first trained parameters 301 according to the updated training parameters 304, that is, updates the original first trained parameters 301 of the first neural network module 33 to the contents of the updated training parameters 304. Thereby, the neural network model can be trained in the electronic device 10, and the trained updated training parameters 304 are updated to the wireless node device 30. Before receiving the updated training parameters 304, the wireless node device 30 may still make predictions through the second neural network module 16 including the latest second trained parameters 302. In other words, even if the wireless node device 30 cannot obtain the updated training parameters 304 from the electronic device 10, it can still use the existing second trained parameters 302 to make predictions through the neural network module 16, so as to obtain prediction results without external sources.

In some embodiments, the current state data 303 includes time information (e.g., time information 43 as described later), signal strength data (e.g., signal strength 476, and operating class and transmitting power 462 as described later), network traffic data (e.g., BSS number 459, channel maximum bandwidth 477 and channel utilization rate 479 as described later), network latency data (e.g., physical distance information 454 and topological distance information 455 as described later), and noise data (e.g., noise index 478 as described later), which are input as data samples to the first neural network module 33 for prediction. Similarly, training samples of the second neural network module 16 include the aforementioned time information, signal strength data, network traffic data, network latency data, noise data and other factors as input to the units of the long short-term memory 51.

In some embodiments, the estimated network data 305 includes a channel selection decision. The channel selection decision includes one or more recommendation channels (e.g., recommendation connection information 76 as described later).

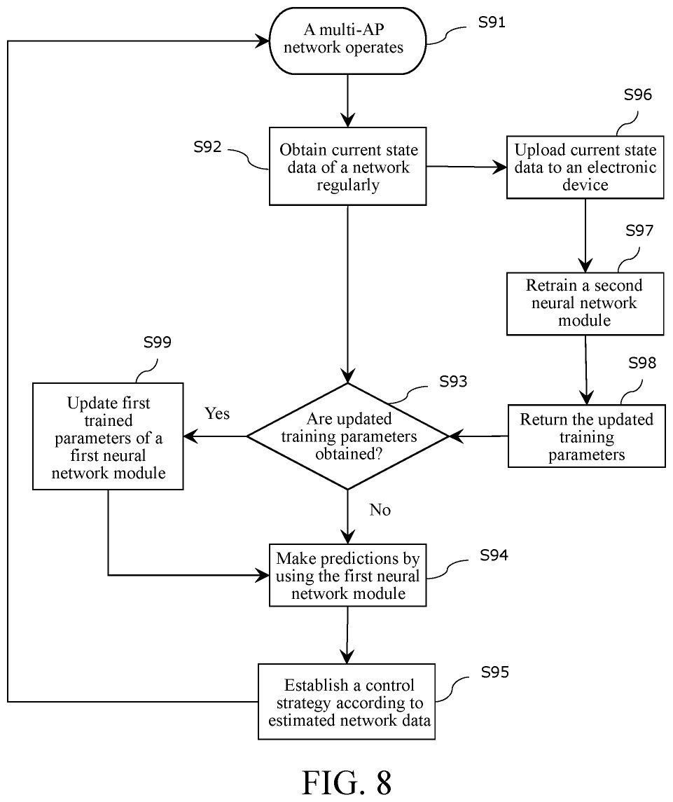

FIG. 8 is a flowchart showing the operation of the network traffic control system according to an embodiment of the present disclosure. When a multi-AP network 20 operates (step S91), a wireless node device 30 obtains current state data 303 of the multi-AP network 20 regularly (step S92). In step S93, the wireless node device 30 determines whether updated training parameters 304 are obtained. If not, then predictions are made based on the current state data 303 by using a first neural network module 33 to obtain estimated network data 305 (S94). Then, the wireless node device 30 establishes a control policy according to the estimated network data 305 to control the wireless network communication circuit 31, for example, switching channels (step S95). In step S96, the wireless node device 30 uploads the current state data 303 to an electronic device 10. The electronic device 10 retrains a second neural network module 16 based on the current state data 303 to obtain the updated training parameters 304 (step S97). In step S98, the electronic device 10 returns the updated training parameters 304 to the wireless node device 30. If the wireless node device determines that the updated training parameters 304 are determined in step S93, then the process goes to step S99, i.e., the wireless node device 30 updates first trained parameters 301 of the first neural network module 33 according to the updated training parameters 304.

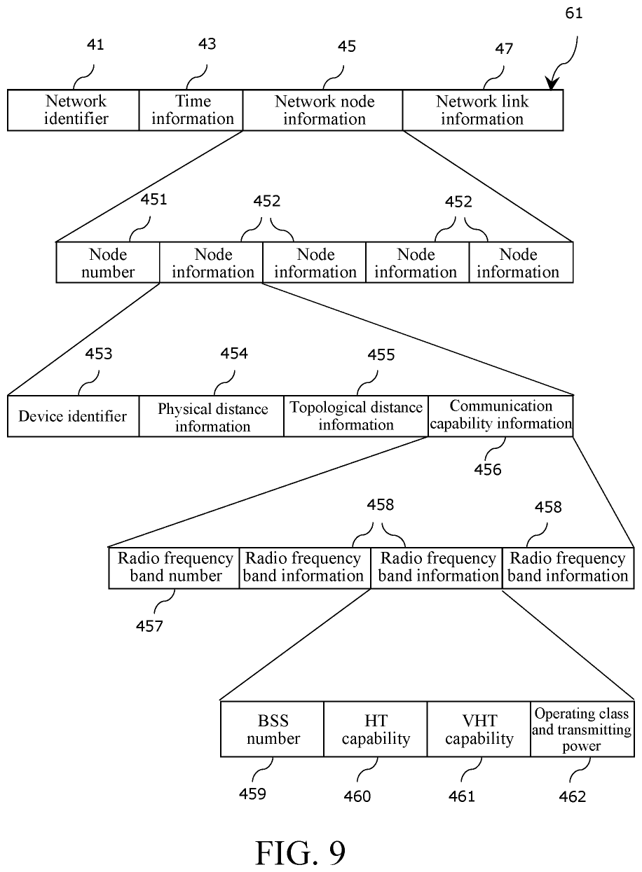

Referring to FIG. 1 and FIG. 9 together, FIG. 9 is a schematic diagram (I) showing contents of upload data 61 transmitted by the wireless node device 30 according to an embodiment of the present disclosure. The upload data 61 includes a network identifier 41, time information 43, network node information 45 and network link information 47. The network identifier 41 is a unique number for identifying which multi-AP network 20 the received upload data 61 comes from. The network identifier 41 is used for identification purposes and is not used as training data for the neural network structure. The time information 43 is the current time, which can include year, month, day, hour, minute and other information. The network node information 45 refers to information of each of network nodes 21 to 24 in the multi-AP network 20, network capability, etc. The network link information 47 refers to information of each link (link between two of the network nodes 21 to 24) in the multi-AP network 20.

Specifically, the network node information 45 may include the number of the network nodes 21 to 24 (node number 451) and node information 452 of the network nodes 21 to 24 in the multi-AP network 20. Here, four node information 452 are shown, respectively corresponding to each of the network nodes 21 to 24.

The node information 452 may include a device identifier 453, physical distance information 454, topological distance information 455 and communication capability information 456. The device identifier 453 is a unique number used for identifying the network nodes 21 to 24, which, for example, may be, a Media Access Control (MAC) address. In an embodiment, the device identifier 453 is used for identification purposes and is not used as training data for the neural network structure. The physical distance information 454 is an estimated physical distance from the corresponding network nodes 21-24 to the controller (here, the network node 21). The topological distance information 455 is a topological distance from the corresponding network nodes 21-24 to the controller (here, the network node 21), which may also be referred to as hop distance. The communication capability information 456 is information related to radio frequency bands supported by the corresponding network nodes 21 to 24.

The communication capability information 456 may include a supportable radio frequency band number 457 and information of corresponding supportable radio frequency bands (radio frequency band information 458). FIG. 9 shows three radio frequency band information 458, which means that three radio frequency bands are supported.

Each radio frequency band information 458 may include a BSS number 459, a high throughput (HT) capability 460, a very high throughput (VHT) capability 461 and an operating class and transmitting power 462. The BSS number 459 refers to the number of BSS in this radio frequency band. The HT capability 460 refers to whether the HT standard is supported. The VHT capability 461 refers to whether the VHT standard is supported. The operating class and transmitting power 462 include two information, including a channel width and a transmitting power. In some embodiments, the operating class can represent the channel width, and thus, can be used instead of the channel width.

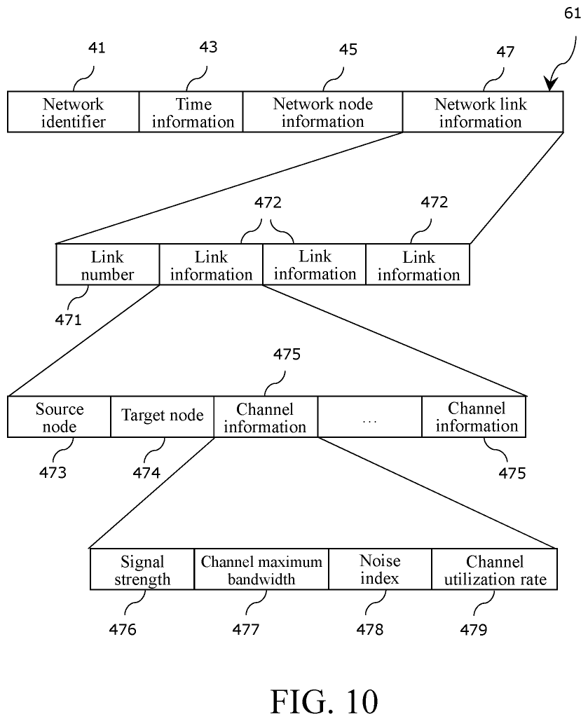

Referring to FIG. 1 and FIG. 10 together, FIG. 10 is a schematic diagram (II) showing contents of upload data 61 transmitted by the wireless node device 30 according to an embodiment of the present disclosure. Here, FIG. 10 shows specific contents of the network link information 47. The network link information 47 may include a link number 471 (3 links in FIG. 1) in the multi-AP network 20 and information of the links (link information 472).

Each link information 472 includes a source node 473 of the corresponding link, a target node 474 of the corresponding link and information of all channels (channel information 475). Taking the link between the network node 21 and the network node 22 as an example, the source node 473 is the network node 21, and the target node 474 is the network node 22. The channel information 475 may include the signal strength 476 corresponding to the channel (e.g., RSSI), the maximum bandwidth for the operation of the corresponding channel (channel maximum bandwidth 477), the noise index 478 and the channel utilization rate 479. The noise index 478 is an index of an average radio frequency band noise plus interference power. The channel utilization rate 479 is the proportion of busy time of the corresponding channel.

The aforementioned factors (except for those specifically marked not to be used as training data) may be input as data samples to the first neural network module 33 for prediction, and may also be used as training samples for the second neural network module 16.

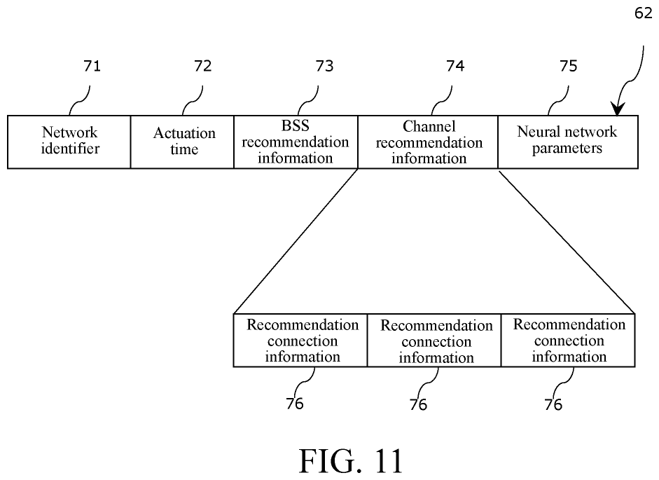

Referring to FIG. 1 and FIG. 11 together, FIG. 11 is a schematic diagram showing contents of download data 62 received by the wireless node device 30 according to an embodiment of the present disclosure. The download data 62 includes a network identifier 71 and neural network parameters 75. After completing the training according to the training samples of the multi-AP network 20 of the corresponding network identifier 41, the electronic device 10 may transmit the updated training parameters 304 to the wireless node device 30 of the multi-AP network 20 of the corresponding network identifier 71 through the download data 62, so that the wireless node device 30 can update the first trained parameters 301.

In some embodiments, the electronic device 10 may also obtain the estimated network data 305 by making predictions based on the received data samples by using the second neural network module 16. Then, the electronic device 10 puts the estimated network data 305 into the download data 62, so that the wireless node device 30 receiving the download data 62 operates according to the estimated network data 305. The estimated network data 305 put into the download data 62 may include an actuation time 72, BSS recommendation information 73 and channel recommendation information 74. The actuation time 72 is a suggested time for executing the traffic control policy, which may include information such as time and minute. The BSS recommendation information 73 records which specific BSS of each wireless node device 30 is estimated to have better performance, so that when a new client wants to connect to the corresponding wireless node device 30, the specific BSS recorded can be used first. The channel recommendation information 74 includes one or more recommendation connection information 76. Here, three recommendation connection information are taken as an example. The recommendation connection information 76 records the predicted information of top channels of each link, which may include channel number and bandwidth. Therefore, the wireless node device 30 may switch the link to a first recommendation channel recorded in the recommendation connection information 76 at the actuation time 72, and may switch to a second recommendation channel according to the recommendation order if the expected effect is not achieved, and so on.

In some embodiments, the estimated network data 305 may be obtained by the wireless node device 30 based on the data samples by using its own the first neural network module 33 to predict and perform corresponding operations. Here, the download data 62 may not include the actuation time 72, the BSS recommendation information 73 and the channel recommendation information 74.

In some embodiments, the wireless node device 30 with the controller status may collect the network node information 45 and the network link information 47 of the other wireless node devices 30 in the same multi-AP network 20, integrate the network node information and the network link information of the other wireless node devices with the network node information 45 and the network link information 47 of its own, and transmit the upload data 61 to the electronic device 10. Similarly, the wireless node device 30 with the controller status obtains the updated training parameters 304 from the electronic device 10 and transmits the updated training parameters to the other wireless node devices 30.

In some embodiments, the electronic device 10 obtains the current state data 303 of a plurality of multi-AP networks 20 in advance, and pre-trains the second neural network module 16 to obtain the second trained parameters 302. The second trained parameters 302 are also pre-stored in the wireless node device 30 to form the first trained parameters 301.

In some embodiments, the electronic device 10 loads the corresponding second trained parameters 302 according to the network identifier 41 so as to train the second neural network module 16. Therefore, single electronic device 10 may cooperate with a plurality of multi-AP networks 20.

According to the network traffic control system and the wireless node device 30 thereof provided in some embodiments of the present disclosure, the network condition can be predicted in the wireless node device 30 through the neural network model and a traffic control policy can be determined. Moreover, the current state data 303 can be transmitted to the electronic device 10 so as to be trained, and the updated training parameters 303 can be transmitted back to the wireless node device 30 for updating. In this way, the neural network model can continuously learn and adapt to the user's habits and environment, and generate the traffic control policy according to the latest parameters.

What is claimed is:

1. A wireless node device, comprising:
a first neural network module, having a plurality of first trained parameters;
a wireless network communication circuit; and
a control circuit, coupled to the first neural network module and the wireless network communication circuit, and configured to obtain, from the wireless network communication circuit, a plurality of current state data corresponding to a plurality of time points, load the first neural network module to obtain estimated network data based on the current state data, and control the wireless network communication circuit according to the estimated network data.

2. The wireless node device according to claim 1, wherein the current state data comprises time information, signal strength data, network traffic data, network latency data and noise data.

3. The wireless node device according to claim 1, wherein the estimated network data comprises a channel selection decision.

4. The wireless node device according to claim 1, wherein the wireless node device is located in a network traffic control system applicable to a multi-AP network, the network traffic control system further comprises an electronic device, and the electronic device has a plurality of second trained parameters; and the electronic device performs training based on the current state data to obtain a plurality of updated training parameters and updates the second trained parameters according to the updated training parameters, the electronic device further transmit the updated training parameters back to the wireless node device such that the wireless node device updates the first trained parameters according to the updated training parameters.

5. The wireless node device according to claim 4, wherein the current state data comprises a network node number in the multi-AP network and network node information of one or more network nodes.

6. The wireless node device according to claim 5, wherein the network node information comprises physical distance information, topological distance information and communication capability information of the network node.

7. The wireless node device according to claim 6, wherein the communication capability information comprises a radio frequency band number and one or more radio frequency band information.

8. The wireless node device according to claim 7, wherein the radio frequency band information comprises a BSS number, an HT capability, a VHT capability, a channel width and a transmitting power.

9. The wireless node device according to claim 4, wherein the current state data comprises a link number in the multi-AP network and one or more link information.

10. The wireless node device according to claim 9, wherein the link information comprises a source node, a target node and a plurality of channel information.

11. The wireless node device according to claim 10, wherein the channel information comprises a signal strength, a channel maximum bandwidth, a noise index and a channel utilization rate corresponding a plurality of channels.

12. The wireless node device according to claim 1, wherein the estimated network data comprises an actuation time, a recommendation node and channel recommendation information.

13. The wireless node device according to claim 12, wherein the channel recommendation information comprises one or more recommendation connection information.
